(19) United States
(12) Patent Application Publication
(10) Pub. No.: US 2014/0298246 A1
(43) Pub. Date: Oct. 2, 2014

(54) AUTOMATIC DISPLAY PARTITIONING BASED ON USER NUMBER AND ORIENTATION

(71) Applicant: LENOVO (Singapore) PTE, LTD., (US)

(72) Inventors: Song Wang, Cary, NC (US); Matthew Lloyd Hagenbuch, Durham, NC (US); Scott Edwards Kelso, Cary, NC (US); John Weldon Nicholson, Cary, NC (US); Jianbang Zhang, Raleigh, NC (US)

(73) Assignee: LENOVO (Singapore) PTE, LTD., New Tech Park (SG)

(21) Appl. No.: 13/853,743

(22) Filed: Mar. 29, 2013

(51) Int. Cl. G06F 3/0481

(52) U.S. Cl. CPC G06F 3/0481
USPC 715/781

(57) ABSTRACT

A method, program product, and apparatus are disclosed for automatic display partitioning based on user number and orientation. In one embodiment, the apparatus includes a detection module that detects a plurality of users, a partitioning module that creates a plurality of display-screen partitions on a display screen, and a positioning module that orients one of the display-screen partitions to correspond to the position of one of the device users in relation to the display screen.

### BACKGROUND

1. Field

The subject matter disclosed herein relates to device display partitioning and more particularly relates to making devices more useful for multiple users using a device simultaneously.

2. Description of the Related Art

The invention and growth of personal computing has led to a revolution in modern life. For example, many people own a variety of electronic devices, such as a smartphone, desktop computer, laptop computer, tablet computer, portable music player, camera, or some combination thereof. In addition to the many different types of devices, there have also developed many different types of each type of each device. For example, there are large tablets, mini tablets, and extra-large tablets. Different devices may have different uses, and therefore appeal to a different user base. A small device might be attractive to a person traveling on a subway, bus, boat, or airplane. A larger device might be attractive to a group of people to use.

### BRIEF SUMMARY

A large tablet device might be attractive for a group of people to use, but all users might not be able to interact as well with a large screen. For example, a user might be seated on the wrong side of the screen and unable to see or read upside down. Additionally, there might be different users that are interested in using the tablet for different tasks.

Based on the foregoing discussion, the inventors have recognized a need for an apparatus, system, and method that provides automatic display partitioning based on user number and orientation. Beneficially, such an apparatus, system, and method would detect the number of users and the position of each user in relation to a device, automatically orienting and positioning a display-screen partition in response to each user's position.

The embodiments of the present invention have been developed in response to the present state of the art, and in particular, in response to the problems and needs in the art that have not yet been fully solved by currently available computer software or hardware. Accordingly, the embodiments have been developed to provide a method, apparatus, and system for automatic display partitioning based on user number and orientation that overcome many or all of the above-discussed shortcomings in the art.

The apparatus to provide automatic display partitioning based on user number and orientation is provided with a plurality of modules configured to functionally execute the necessary steps of providing automatic display partitioning based on user number and orientation. These modules in the described embodiments include a detection module that detects a plurality of users, a partitioning module that creates a plurality of display-screen partitions on a display screen, and a positioning module that orients one of the display-screen partitions to correspond to the position of one of the device users in relation to the display screen.

In a further embodiment, the apparatus includes detecting a position of the user in relation to the device. In another embodiment, the positioning module positions the display-screen partition in relation to the position of the device user. In an additional embodiment, the positioning module orients a second display-screen partition to correspond to a position of a second device user in relation to the display screen.

In another embodiment, the positioning module automatically orients the display-screen partition. In a further embodiment, the positioning module receives a user input regarding a desired orientation of a screen partition. Furthermore, the display-screen partition is oriented to correspond to the user input.

In an additional embodiment, the detection module detects a new position of at least one device user in relation to the display screen. Also, the positioning module re-orients a display-screen partition to correspond to the new position of the user.

In another embodiment, the detection module detects a new device user, the partitioning module creates a new display-screen partition, and the positioning module orients the new display-screen partition to correspond to a position of the new device user.

In a further embodiment, the detection module detects that a device user is no longer using the device, the partitioning module removes a display-screen partition associated with the user no longer using the device, and the positioning module re-orients a plurality of remaining display-screen partitions to adjust for the removed partition.

In an additional embodiment, at least one display-screen partition displays a different image than a second display-screen partition. In another aspect, a display-screen partition may be associated with more than one device user.

A method is also presented for providing automatic display partitioning based on user number and orientation. The method in the disclosed embodiments substantially includes the steps necessary to carry out the functions presented above with respect to the operation of the described apparatus and system. In one embodiment, the method includes detecting, by a device, a plurality of device users and the position of each user in relation to the device. The method also may include creating, by the device, a plurality of display-screen partitions on a display screen. The method may further include orienting, by the device, one of the display-screen partitions to correspond to a position of one of the device users in relation to the display screen.

In a further embodiment, the method includes positioning the display-screen partition in relation to the position of the device user. In another embodiment, the method includes orienting a second display-screen partition to correspond to a position of a second device user in relation to the display screen.

In another embodiment, the method includes detecting, by a device, a new position of at least one device user in relation to the display screen. The method may further include re-orienting, by the device, a display-screen partition to correspond to the new position of the user.

In an additional embodiment, the method includes detecting, by the device, that a device user is no longer using the device. In a further embodiment, the method includes removing, by the device, a display-screen partition associated with the user no longer using the device. In another embodiment, the method includes re-orienting, by the device, a plurality of remaining display-screen partitions to adjust for the removed partition. In a further embodiment, the method includes where a first display-screen partition displays a different image than a second display-screen partition.

A program product is also presented for providing automatic display partitioning based on user number and orientation. The program product may include a computer-readable storage medium storing machine-readable code for execution by a processor to perform operations. The operations may include launching a software application on a device, detecting a plurality of device users and the position of each device user in relation to the display screen, and creating a plurality of users within the software application, each user within the software application corresponding to a detected user.

In a further embodiment, the program product may include where the graphical representation corresponding to each user within the software application corresponds to the position of each user in relation to the display screen. In another embodiment, the program product operations may also include detecting an additional user and creating an additional user within the software application to correspond to the additional user.

References throughout this specification to features, advantages, or similar language do not imply that all of the features and advantages may be realized in any single embodiment. Rather, language referring to the features and advantages is understood to mean that a specific feature, advantage, or characteristic is included in at least one embodiment. Thus, discussion of the features and advantages, and similar language, throughout this specification may, but do not necessarily, refer to the same embodiment.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of the embodiments as set forth hereinafter.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is an illustration of one embodiment of a device that uses automatic display partitioning based on user number and orientation according to the aspects described herein;

FIG. 2 is an illustration of another mode of a device that uses automatic display partitioning based on user number and orientation according to the aspects described herein;

FIG. 3 is an illustration of an embodiment of a device that uses automatic user recognition and orientation according to the aspects described herein;

FIG. 4 is another illustration of an embodiment of a device that uses automatic user recognition and orientation according to the aspects described herein;

FIG. 5 is a schematic block diagram illustrating one embodiment of a device that uses automatic display partitioning according to the aspects described herein;

FIG. 6 is a schematic flow chart diagram illustrating one embodiment of a method for automatic display partitioning based on user number and orientation according to the aspects described herein; and

FIG. 7 is a schematic flow chart diagram illustrating one embodiment of a method for automatic display partitioning based on user number and orientation according to the aspects described herein.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code. The storage devices may be tangible, non-transitory, and/or non-transmission.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in machine readable code and/or software for execution by various types of processors. An identified module of machine readable code may, for instance, comprise one or more physical or logical blocks of executable code that may, for instance, be organized as an object, procedure, or function. Nevertheless, the executables of an identified module need not be physically located together, but may comprise disparate instructions stored in different locations that, when joined logically together, comprise the module and achieve the stated purpose for the module.

Indeed, a module of machine readable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices, and may exist, at least partially, merely as electronic signals on a system or network. Where a module or portions of a module are implemented in software, the software portions are stored on one or more computer readable storage devices.

Any combination of one or more computer readable medium may be utilized. The computer readable medium may be a machine readable signal medium or a storage device. The computer readable medium may be a storage device storing the machine readable code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A machine readable signal medium may include a propagated data signal with machine readable code embodied therein, for example, in baseband or as part of a carrier wave. Such a propagated signal may take any of a variety of forms, including, but not limited to, electro-magnetic, optical, or any suitable combination thereof. A machine readable signal medium may be any storage device that is not a computer readable storage medium and that can communicate, propagate, or transport a program for use by or in connection with an instruction execution system, apparatus, or device. Machine readable code embodied on a storage device may be transmitted using any appropriate medium, including but not limited to wireless, wireline, optical fiber cable, Radio Frequency (RF), etc., or any suitable combination of the foregoing.

Machine readable code for carrying out operations for embodiments may be written in any combination of one or more programming languages, including an object oriented programming language such as Java, Smalltalk, C++ or the like and conventional procedural programming languages, such as the “C” programming language or similar programming languages. The machine readable code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by machine readable code. These machine readable code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The machine readable code may also be stored in a storage device that can direct a computer, other programmable data processing apparatus, or other devices to function in a particular manner, such that the instructions stored in the storage device produce an article of manufacture including instructions that implement the function or act as specified in the schematic flowchart diagrams or schematic block diagrams block or blocks.

The machine readable code may also be loaded onto a computer, other programmable data processing apparatus, or other devices to cause a series of operational steps to be performed on the computer, other programmable apparatus or other devices to produce a computer implemented process such that the program code that execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and machine readable code.

Descriptions of Figures may refer to elements described in previous Figures, like numbers referring to like elements.

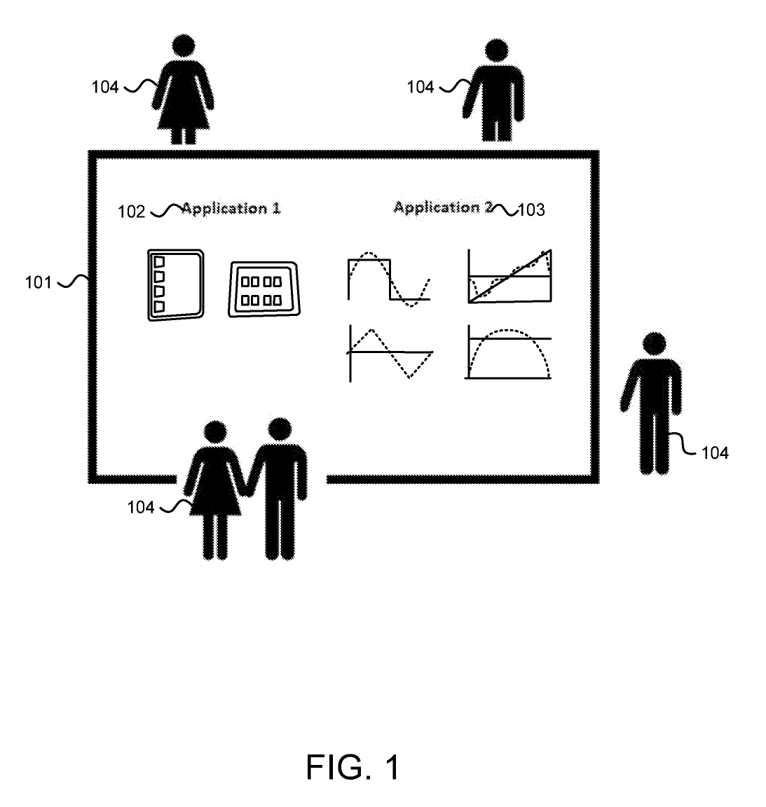

FIG. 1 depicts one embodiment of a device 101 that implements automatic display partitioning based on user number and orientation. In the depicted mode, the device 101 is not partitioning or orienting based on user number or user orientation.

In one embodiment, automatic display partitioning may be implemented on a tablet computing device, such as the LENOVO IdeaCentre Horizon Table PC. Another embodiment may include another brand or model of tablet computing device, or another touchscreen device such as a smartphone. In a further embodiment, automatic display partitioning may be implemented by another computing device such as a desktop computer, laptop computer, a mobile telephone, a personal digital assistant, or another computing device.

The device 101 includes a display screen that shows multiple applications 102, 103. Applications 102, 103 as depicted are both displayed on the screen at the same time. Both applications 102, 103 are oriented to split the screen equally, and are oriented in the same direction. In one embodiment, both applications may receive input simultaneously. In another embodiment, while both applications may display output simultaneously, only one application may receive input at a time.

Users 104 surround the device 101. Note that the display and orientation of the applications 102, 103 is not relative to the number or location of users in the depicted embodiment.

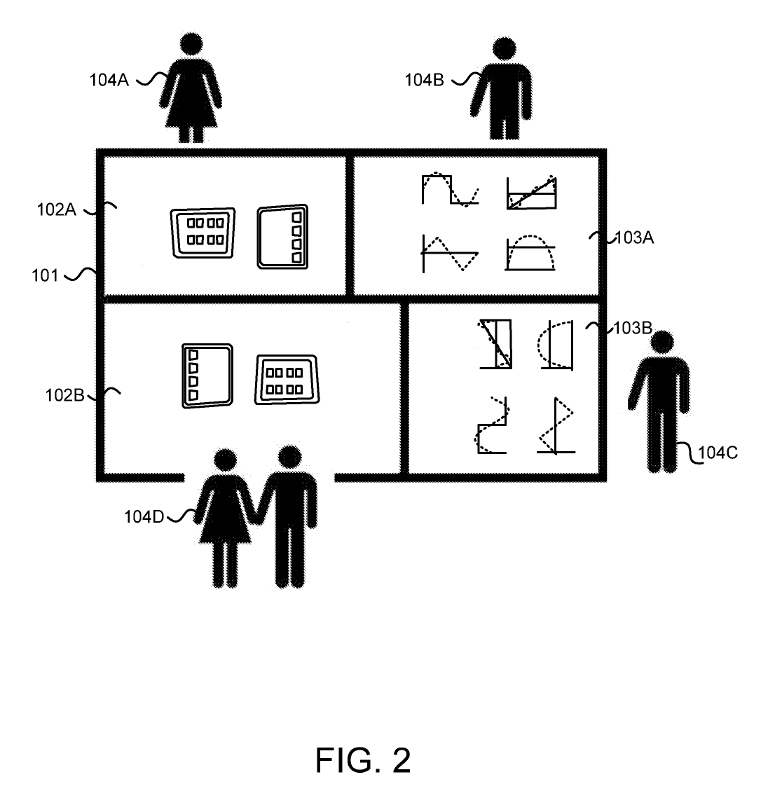

FIG. 2 depicts a different mode of the device 101, where the device 101 is implementing automatic display partitioning and orientation based on user number and user orientation.

The device 101 divides and orients the display into four unique partitions. Each partition is displaying an application 102, 103. Each partition is uniquely sized and oriented. Each partition sizes and orients relative to the position of the user or users relative to the device 101.

The device 101 detects the number of users. The device 101 may use any of a number of technologies, or combination of technologies, to detect users. For example, the device might include an RFID reader to detect one or more RFID chips associated with each user. For example, a user might carry a cellular telephone that includes an RFID chip. There might be RFID chips embedded in the users' clothing, or users might have an RFID chip embedded in their skin. The device 101 senses the RFID chip to detect the number of users. Additionally, the device 101 may sense the RFID chip to detect the proximity of the user to the device 101, as well as the orientation or location of the user in relation to the device 101. The device 101 may, in one example, detect the identity of each user.

In another example, the device 101 may use NFC, BLUETOOTH, wireless radio, or some other technology to detect the number of users, as well as the orientation and location of each user in relation to the device 101.

In another example, the device 101 may include a camera that detects the number of users, as well as the orientation and location of each user in relation to the device 101. The camera may use retina scanning, facial recognition, or some other identification technology to identify the identity of each user.

The device 101 creates one or more display-screen partitions on the device display screen. Each partition may, in one embodiment, be associated with one or more users. For example, in the depicted embodiment, display-screen partition 102A may be associated with user 104A, display-screen partition 103A may be associated with user 104B, display-screen partition 103B may be associated with user 104C, and display-screen partition 102B may be associated with users 104D.

In one embodiment, at least one display-screen partition displays a different image than a second display-screen partition. For example, in the depicted embodiment, display-screen partitions 102A and 102B display different images than display-screen partitions 103A and 103B. Different display-screen partitions may display the same or differing applications, images, videos, or other content. In one embodiment, one display-screen partition may not show anything while another partition shows something. In another embodiment, more than one display-screen partition shows the same image or content. For example, display-screen partitions 102A and 102B show the same content, and display screen partitions 103A and 103B show the same content.

The device 101 may, in one embodiment, detect that more than one user is in close proximity to another user, as is depicted with users 104D using application 102B in FIG. 2. In that case, the device associates the partition displaying application 102B with both users 104D. Alternatively, the camera might use eye-tracking technology to track which application each user is using. For example, users 104D might both be looking at or engaging with application 102B. Because both users 104D are in close proximity to each other, and are using the same application 102B, the device 101 only provides one partition for both users to watch and interact with. If one of the users 104D started looking at a different application, for example 103B, then the device 101 might create a fifth partition to display application 103B, and orient the partition towards the user 104D that was watching the other application 103B.

The device 101 also may orient one of the display-screen partitions to correspond to a position of one of the device users 104 in relation to the display screen. For example, in the depicted embodiment, there are five users, and four partitions. Each partition is oriented to display its corresponding application 102, 103 in relation to the position each of the one or more users in relation to the display screen. For example, if the device 101 is laying flat on top of a table, and users 104 are gathered around the table, each partition orients its application to face each user. That is, application 102A only uses part of the screen of device 101—it uses a screen partition to display—and it is oriented towards user 104A. Similarly, application 103A uses a screen partition to display and is oriented towards user 104B Likewise, application 103B is oriented in a different direction than applications 102A, 103A, 102B—application 103B is oriented towards user 104C. Also, application 102B is oriented towards users 104D, who are in close proximity to each other. Orientations may be in any direction. For example, a partition might be oriented only a few degrees in a direction in order to better face a user, or might be 180 degrees different than another partition.

In one embodiment, the display-screen partition is automatically oriented by the computing device 101. In another embodiment, the display-screen partition is configured in response to a user input. For example, a user may input to the device 101 to ignore her presence. The device then ignores the presence of that user. In another example, the user might manually resize or re-orient a partition. The user might create an additional partition, so that the user can use two different partitions simultaneously. Each partition may be oriented the same way, or might be oriented in different directions.

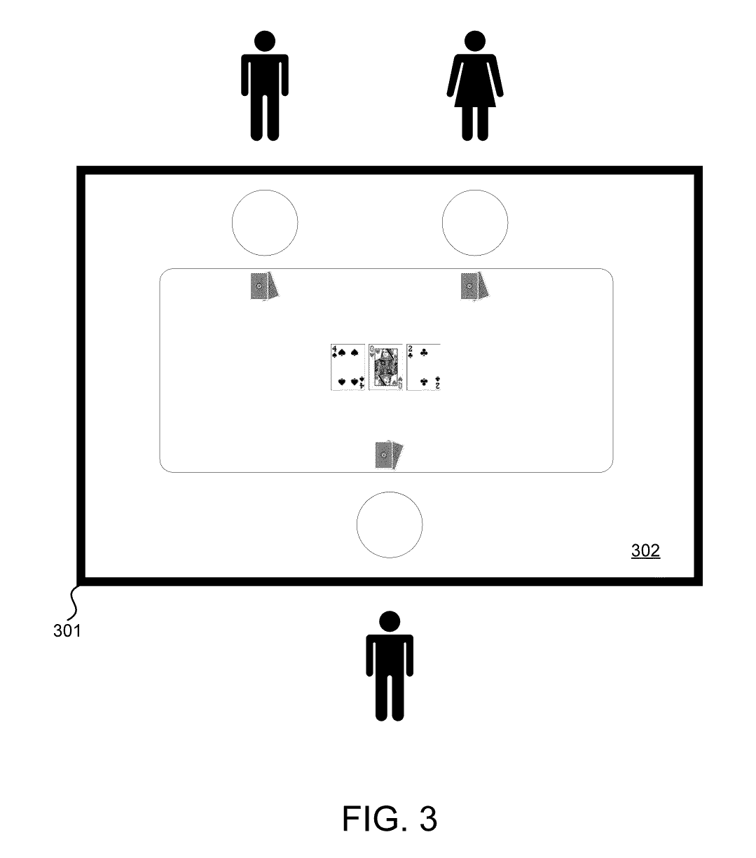

FIG. 3 depicts another embodiment of a device 301 that detects the number and proximity of users in relation to the device 301. The device may, in the depicted embodiment, launch a software application on the device. In the depicted example, the software application is a poker game.

The device may also detect one or more users and the position of each user in relation to the device display screen. For instance, in the depicted example, there are three users around the device. The device may detect the number of users, and the location of each user, before launching the software application. In another embodiment, the device may launch the software application before detecting the number of users and the location of each user. In another embodiment, the device may continue to detect the number and position of users whether a software application is running or not.

The device may, as in the depicted embodiment, create a graphical representation corresponding to each user within the software application, each graphical representation corresponding to the position of each user in relation to the display screen. In other words, there may be one or more users within the software application. Each user in the software application may, in one embodiment, correspond to a detected user. For example, there are three users around the device in FIG. 3. Software application 302 includes three locations corresponding to the location of each user around the virtual poker table. That is, the poker software application created a seat at the table for each user in response to the device detecting the existence and location of each user. Each player may then play his or her hand in the poker game hosted on the device.

Such a response is not limited to a digital poker application. Any application with one or more users may automatically create one or more in-game users that each correspond to a real-life user of the device. For example, there may be multiple users for another type of card game, a virtual board game, another game, or another application, such as a photo-viewing app, a shared payment app, a restaurant ordering menu, or any other application with one or more users. The device detects the number and position of each user, and one or more applications running on the device may respond by creating one or more users within the software application.

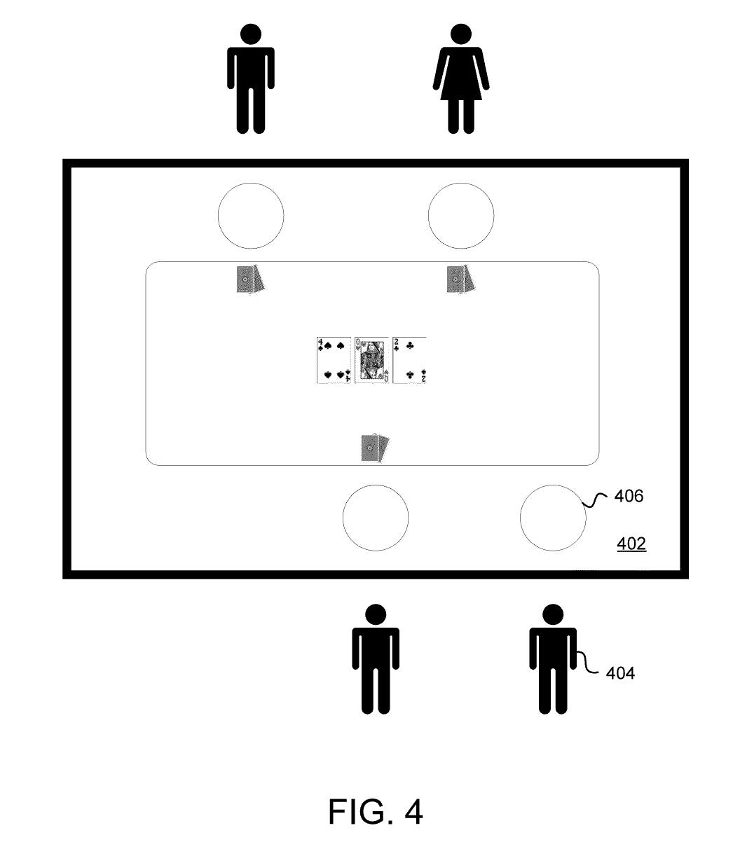

FIG. 4 depicts the same device and poker game software application as was depicted in FIG. 3. An additional user 404 has just approached the device. The device detects the appearance of an additional user 404, as well as the additional user 404 location. In response, the device creates an additional user within the software application to correspond to the additional user. In the depicted example, because additional user 404 approached the device in the middle of a hand, new user is not dealt a hand of cards until the end of the current hand. In one embodiment, the software application 402 might require user 404 to confirm the addition of the new seat 406 to the game. For instance, the new user 404 might only want to watch, but not join in, the game. In another example, the new user 404 might want to join the game, but not at the moment he approached the device.

In another embodiment, the device detects the departure of a user. For example, if a user leaves from standing nearby the device, the device might detect that the user is no longer nearby the device. In one instance the user's departure might indicate that the user is no longer using the application. In one embodiment, the device might automatically remove the departed user's seat or other graphical user representation from the software application 402. In another embodiment, the response to user departure might depend on the current state of the application. For instance, if the application 402 is a poker game, and the user still has an active hand, the user's departure might not result in removing the user from the game. But in another example, if the user recently folded, bet and lost, or the game is between hands, the departure of the user might result in the removal of the user from the game. As mentioned earlier, in one embodiment the user might be able to manually override any automatic response to a user arrival, movement, or departure.

In another embodiment, the device detects the movement of a user. For example, if one of the users from the bottom of the Figure move to the right side of the device, then the user's corresponding seat might, in one embodiment, move to correspond to the user's new location. In another embodiment, the user might tell the device not to move the seat—for example if the user was simply going to get a tissue or some other item in a different location in the room, and would be returning to the original location.

In one example, the user might select or otherwise provide a manual command or setting to prevent the application from automatically moving, adding, removing, or otherwise updating a user's virtual representation within an application. In another example, a user might have the option to set whether to move or update his or her seat automatically. That is, one user might want the device to move his virtual seat around the table as he walks around the table, while another user might not want the device to move her virtual seat around the table as she walks around the table. The device, in one embodiment, can be programmed to respond to such programmed user preferences. In another embodiment, the response may be software application specific, or in another embodiment may be a device system-wide setting.

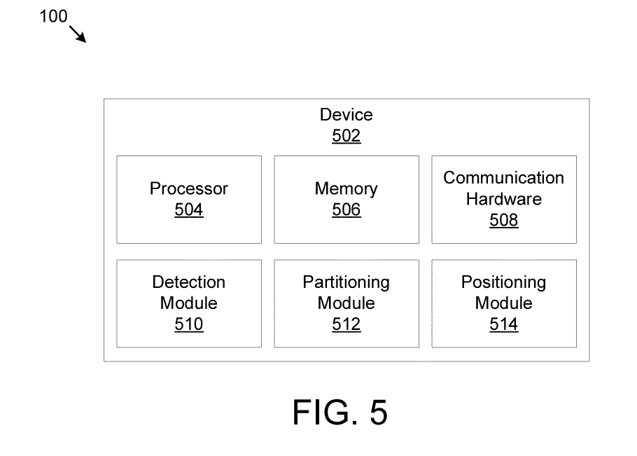

FIG. 5 is a graphical block diagram representing one embodiment 500 of a device 502 that automatically partitions a display in relation to user number and orientation.

Device 502 may include a processor 504, memory 506, communication hardware 608, detection module 510, partitioning module 512, and positioning module 514.

The memory 506 may be a computer-readable storage medium such as a semiconductor storage device, a hard-disk drive, an optical-storage device, a holographic-storage device, a micromechanical storage device, or a combination thereof. The memory 506 may store machine readable code. The processor 504 may execute the machine readable code.

The communication hardware 508 may communicate with a touch-sensitive screen that receives commands or configuration information. The communication hardware 508 might include an input/output controller (TO controller) that receives and processes a user's touch commands. In another embodiment, a remote controller may send commands to the device 502 by transmitting a signal to the communication hardware 508. In another example, a mobile device may transmit commands wirelessly, such as from a smart phone, tablet computer, or the like. In another embodiment, the communication hardware 508 may receive input from a computing device. For example, a personal computer may connect to the communication hardware 508 via a wired connection. As one skilled in the art would appreciate, input may be transmitted using a wide variety of connection technologies, including, but not limited to, Ethernet, USB, FireWire, GPIB, or other, or the like.

In one embodiment, detection module 510, partitioning module 512, and positioning module 514 are embodied in a computer-readable storage medium such as the memory 506 storing machine-readable code. The processor 504 may execute the machine readable code to perform the functions of the apparatus 500.

Alternatively, detection module 510, partitioning module 512, and positioning module 514 may be embodied in semiconductor gates. The semiconductor gates may be embodied in a touch screen, a discrete device, or combinations thereof. Alternatively, the detection module 510, partitioning module 512, and positioning module 514 may be embodied in combinations of semiconductor gates and the computer-readable storage medium.

The detection module 510 may detect one or more device users. For example, the device might include a camera, RFID sensor, or some other technology for sensing a user's proximity to the device. The camera might use facial recognition technology to detect how many users there are. In one embodiment, a user might carry a smartphone with an RFID chip embedded, or have an RFID chip embedded under the skin. Another embodiment might use some other technology, such as BLUETOOTH, near-field communication (NFC), global positioning system (GPS), or another location sensing technology for sensing a user's proximity to the device.

In another embodiment, the detection module 510 may further include detecting a user's position in relation to the device. For example, the detection module 510 might sense that a first user is one foot away from the device, where a second user is five feet away from the device. Additionally, the detection module 510 might detect that one user is on one side of the device, and a second user is on another side of the device. Alternatively, the detection module 510 might detect that two users are sitting or standing next to each other next to the device.

The partitioning module 512 may create one or more display-screen partitions on a display screen. A display-screen partition may be a division of a device display screen. Different display-screen partitions may have different characteristics or settings. For example, different display-screen partitions may have different resolutions, sizes, touch sensitivities, color settings, or the like. Different display-screen partitions may have different hardware access—for example, one display-screen partition may have exclusive access to a device camera, speaker, or headphone jack. In another embodiment, different display-screen partitions may alternate, simultaneously use, or otherwise share device hardware.

The positioning module 514 may orient one of the display-screen partitions to correspond to the position of one of the device users in relation to the display screen. For example, as illustrated in FIG. 2, partition 102A is oriented to correspond to the position of user 104A, while partition 102B is oriented to correspond to the position of users 104D.

In a further embodiment, the positioning module positions the display-screen partition in relation to the position of the device user. For example, in FIG. 2, partition 103B is positioned in relation to the position of device user 104C.

In another embodiment, the positioning module orients a second display-screen partition to correspond to a position of a second device user in relation to the display screen.

In an additional embodiment, the positioning module automatically orients the display-screen partition. For example, if in FIG. 2 user 104A walked towards users 104D, the partition 102A might automatically reposition to continue to be in the best viewing position for user 104A. In such an example, the other partitions 102B, 103A, 103B may move or be adjusted in order to maintain the best viewing angle for all users with their respective partitions. In one embodiment, the device automatically determines what the best viewing position, orientation, angle, size, and the like is for each user. In another embodiment, the device may include settings for establishing how the device automatic response should function. For example, different users may have different preferences that the device may learn.

In an alternative embodiment, the positioning module may receive a user input regarding a desired orientation of a screen partition, and the display-screen partition is oriented to correspond to the user input. For example, instead of automatically shifting, moving, reorienting, or repositioning a display-screen partition, the device might give the user the option to manually set the position, orientation, or other settings for a display-screen partition. In one example embodiment, a user might get up to go get a drink while using a tablet computer. Instead of having the tablet detect that the user has departed (and get rid of her partition), the user might choose to manually tell the tablet to not adjust her partition. In another example, a user might wish to pace back and forth while thinking aloud about dictations for the latest chapter of the book he is writing. Rather than having a partition follow him back and forth along the screen, he may set the partition to stay in a fixed position.

In one embodiment, the detection module 510 detects a new position of at least one device user in relation to the display screen. For example, a user may move from one side of a device to another. The positioning module 514, in response, may re-orient the display-screen partition to correspond to the new position of the user.

In one embodiment, the detection module 510 detects a new device user. For example, a new user might have approached the device. If the new user has an RFID-enabled smartphone, and the device is using RFID technology as one way to detect new users, the device might detect the new user's smartphone to determine the presence of a new user, the user's position and orientation in relation to the device, and any other relevant information. The partitioning module 514, in response, creates a new display-screen partition. The partitioning module 514 further orients the new display-screen partition to correspond to a position of the new device user.

In one embodiment, the detection module 510 may detect that a device user is no longer using the device. The partitioning module 512 may, in response, remove a display-screen partition associated with the user no longer using the device. The positioning module 514 might, in response, re-orient a plurality of remaining display-screen partitions to adjust for the removed partition.

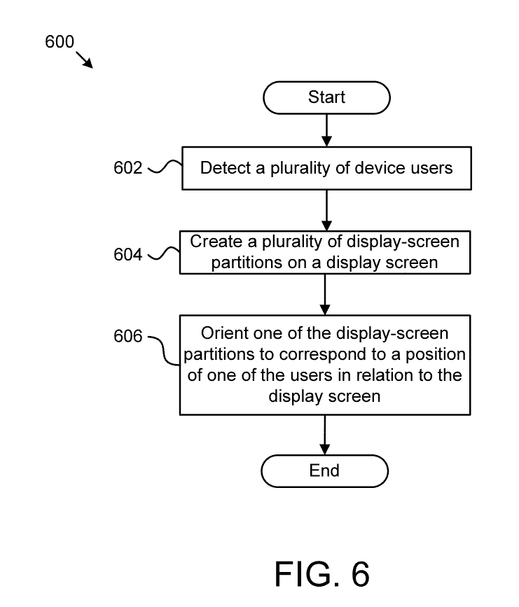

FIG. 6 is a schematic flow chart diagram illustrating one embodiment of a method for automatic display partitioning based on user number and orientation according to the aspects described herein.

A device begins by detecting 602 a plurality of device users.

The detection 602 might detect one user, or in another embodiment more than one user. In one embodiment, two users physically located near each other—such as sitting or standing next to each other—might be considered one user. In another embodiment, the device might detect 602 both users, but consider them to be one for purposes of partitioning and orienting.

After detection 602, the device creates 604 a plurality of display-screen partitions on a display screen. The plurality of display-screen partitions may correspond to the number of device users. For example, if the display is sitting on a tabletop surrounded by four users, with one user sitting on each side, the device might create four partitions.

In another instance, the device might create fewer partitions than the number of users. For example, if there are four users sitting on the same side of the device, the device might create four or fewer partitions. In one embodiment, the device might only display one partition—that is, the entire screen is filled with the same display.

In a further example, the device might create more partitions than the number of users. For example, if one user wishes to use multiple partitions at the same time, there might be more than one partition per user. For example, if a user wants to watch her favorite television show on one partition, while going over a work project on another partition, the device might have more than one partition per person.

Next the device orients 606 one of the display-screen partitions to correspond to a position of one of the users in relation to the display screen. In one example, the device orients 606 one of the partitions, while in another example the device orients 606 every partition. The device may, in one embodiment, orient 606 each partition to face each user that the partition corresponds to.

In another embodiment, the device may detect 602 that there is more than one user in close proximity, and create 604 one partition for those more than one users to both use. In that case, the device may orient 606 the shared partition to be equidistant and at a similar orientation in respect to each user. For example, if there are two users standing in close proximity to each other and a device, the device might only provide them with one partition to share between them. To make sharing easier, the partition might be the same distance from each user.

In another instance, even if two users are close together, the device might detect that each should have a distinct partition. For example, if two users are sitting on a corner of a device, the device might create 604 two partitions, orienting 606 each partition to face each user. In another example, the device might create 604 one partition, orienting 606 the partition to be facing the corner in between the two users.

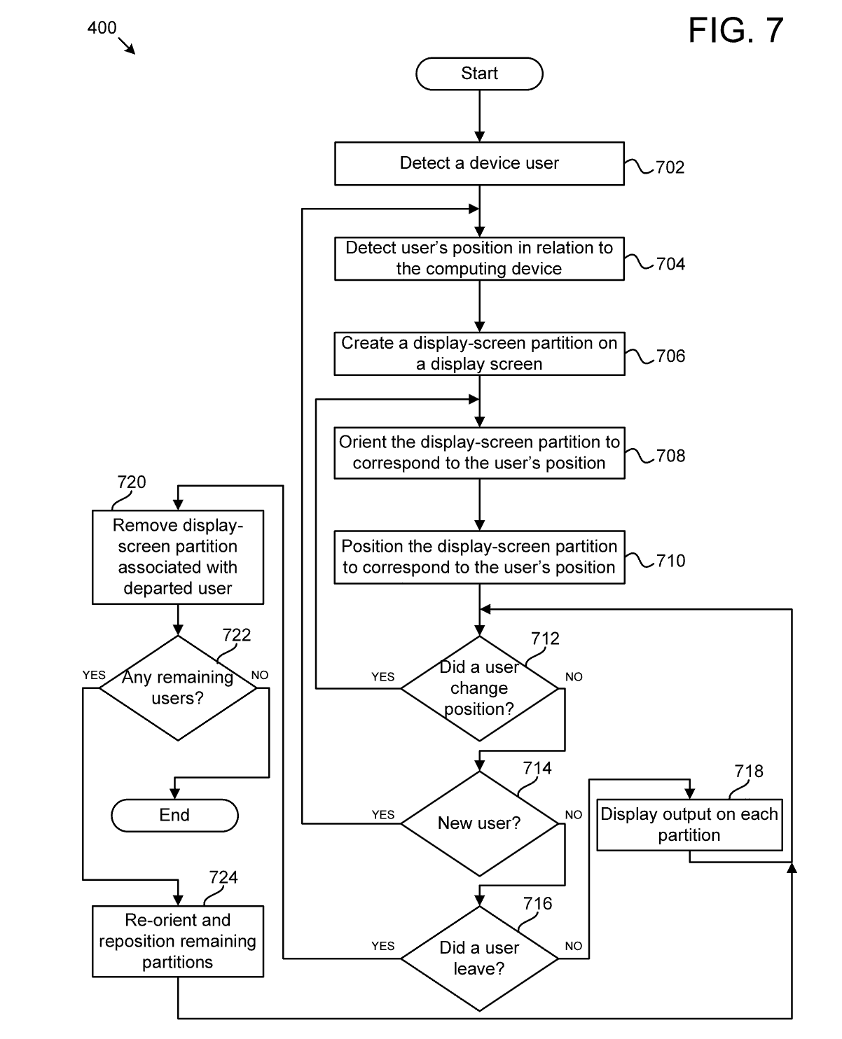

FIG. 7 is a schematic flow chart diagram illustrating one embodiment of a method for automatic display partitioning based on user number and orientation according to the aspects described herein.

The device detects 702 a device user. This step may be substantially similar to the detection 702 described in relation to other figures.

After detecting a user, the device detects 704 user position in relation to the computing device. The device may, for instance, use technology like that described in connection with the detection module 510 of FIG. 5. For example, it might use an RFID sensor for detecting the user's position.

Next, the device may create 706 a display-screen partition on a display screen. For example, a screen may be divided into portions, where each portion is a single display-screen partition.

Next, the device may orient 708 the display-screen partition to correspond to the user's position. For example, a user may be seated on a side of the device that an initial partition was not facing. After detecting that the user is oriented in a different way in relation to the device, the device may orient 708 the display-screen partition to correspond to the user's position.

Next, the device may position 710 the display-screen partition to correspond to the user's position. For example, a user may be seated on a side of the device that an initial partition was not facing. After detecting that the user is positioned in a different way in relation to the device, the device may position 710 the display-screen partition to correspond to the user's position.

Next, the device determines 712 whether a user changed position. If a user changed position, the device orients 708 the display-screen partition to correspond to the user's position. For example, the device may detect a new position a device user in relation to the display screen. The user may have walked to a different position in relation to the device, changed chairs, or through some other method changed position. The device then re-orients a display partition to correspond to the new position of the user.

If the device determines 712 that the user did not change position, the device determines 714 whether there is a new user. If there is a new user, the device may detect 704 the user's position in relation to the computing device. For example, if the detected new user is a second user, the device detects 704 the second user's position in relation to the computing device, creates 706 a second display-screen partition on a display screen, orients 708 the second display-screen partition to correspond to the second user's position, and positions 710 the second display-screen partition to correspond to the user's position.

If the device determines 714 that there is not a new user, the device determines 716 whether a user left. In one embodiment the device might use similar technology for determining whether a user left as the device uses for determining 702 whether there is a new user. For example, the device might include a camera that detects the presence or face of one or more device users. The camera or other technology may, in one embodiment, detect that the users are all still present and using the device.

If no users left the proximity of the device, the device then may, in one embodiment, display 718 output on each display-screen partition. For example, there may be multiple partitions, each associated with a user of the device. One partition may display a first application, a second partition display a second application, and the like. In another embodiment, there may be more than one partition that displays the same application. The device then returns to detecting 712 whether a user changed position.

Alternatively, when determining 716 whether a user left, the camera may, in one embodiment, detect that a user is no longer present or using the device. If the device determines 716 that a user left or is for some other reason no longer using the device (e.g. sleeping, talking to another human, distracted, using another device, etc.), then the device may remove 720 the display-screen partition associated with the departed user.

Alternatively, in another embodiment, the device may detect that there is still a user using the display-screen partition associated with the departed user—i.e. there was more than one user associated with that partition. If there is still a user associated with the partition, then the device may not remove the partition.

After removing 720 the display-screen partition, the device determines 722 if there are any remaining users of the device. For example, the most recently departed user may have been the last or only user. If there are no more users, the method ends.

If there is still at least one device user, the device re-orients 724 and repositions one or more remaining display-screen partitions to adjust for the removed partition. For example, if there were three users using partitions each sized to fill one third of the screen, and one user leaves, the device may resize the remaining partitions to each fill half of the screen. The device may re-orient or reposition to provide a better experience for the remaining user. For example, the partition may be closer, bigger, or otherwise more accessible.

Embodiments may be practiced in other specific forms. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. An apparatus comprising:
a memory having code stored therein;
a display screen;
a CPU which is coupled to said memory and to said display screen and which executes the code stored in said memory, the code comprising:
a detection module that detects a plurality of device users;
a partitioning module that creates a plurality of display-screen partitions on a display screen; and
a positioning module that orients one of the display-screen partitions to correspond to the position of one of the device users in relation to the display screen.

2. The apparatus of claim 1, wherein the detection module includes detecting a position of the user in relation to the device.

3. The apparatus of claim 1, wherein the positioning module positions the display-screen partition in relation to the position of the device user.

4. The apparatus of claim 1, wherein the positioning module orients a second display-screen partition to correspond to a position of a second device user in relation to the display screen.

5. The apparatus of claim 1, wherein the positioning module automatically orients the display-screen partition.

6. The apparatus of claim 1, wherein the positioning module receives a user input regarding a desired orientation of a screen partition, and wherein the display-screen partition is oriented to correspond to the user input.

7. The apparatus of claim 1, wherein the detection module detects a new position of at least one device user in relation to the display screen, and the positioning module re-orients a display-screen partition to correspond to the new position of the user.

8. The apparatus of claim 1, wherein the detection module detects a new device user, the partitioning module creates a new display-screen partition, and the positioning module orients the new display-screen partition to correspond to a position of the new device user.

9. The apparatus of claim 1, wherein the detection module detects that a device user is no longer using the device, the partitioning module removes a display-screen partition associated with the user no longer using the device, and the positioning module re-orients a plurality of remaining display-screen partitions to adjust for the removed partition.

10. The apparatus of claim 1, wherein at least one display-screen partition displays a different image than a second display-screen partition.

11. The apparatus of claim 1, wherein a display-screen partition is associated with more than one device user.

12. A method comprising:
detecting, by a device, a plurality of device users and the position of each user in relation to the device;
creating, by the device, a plurality of display-screen partitions on a display screen; and
orienting, by the device, one of the display-screen partitions to correspond to a position of one of the device users in relation to the display screen.

13. The method of claim 12, further comprising positioning the display-screen partition in relation to the position of the device user.

14. The method of claim 12, further comprising orienting a second display-screen partition to correspond to a position of a second device user in relation to the display screen.

15. The method of claim 12, further comprising:
detecting, by the device, a new position of at least one device user in relation to the display screen; and
re-orienting, by the device, a display-screen partition to correspond to the new position of the user.

16. The method of claim 12, further comprising:
detecting, by the device, that a device user is no longer using the device;
removing, by the device, a display-screen partition associated with the user no longer using the device; and
re-orienting, by the device, a plurality of remaining display-screen partitions to adjust for the removed partition.

17. The method of claim 12, wherein a first display-screen partition displays a different image than a second display-screen partition.

18. A program product comprising a computer-readable storage medium storing machine-readable code for execution by a processor to perform the operations of:
launching a software application on a device;
detecting a plurality of device users and the position of each device user in relation to the display screen; and
creating a plurality of users within the software application, each user within the software application corresponding to a detected user.

19. The program product of claim 18, wherein the graphical representation corresponding to each user within the software application corresponds to the position of each user in relation to the display screen.

20. The program product of claim 18, the machine-readable code for execution by the processor to further perform the operations of:
detecting an additional user; and
creating an additional user within the software application to correspond to the additional user.
